(19) United States
(12) Patent Application Publication
(10) Pub. No.: US 2012/0191271 A1
(43) Pub. Date: Jul. 26, 2012

(54) METHOD AND SYSTEM FOR THE LANE MONITORING OF A MOTOR VEHICLE, MOTOR VEHICLE, AND INFRASTRUCTURE DEVICE

(75) Inventor: Hagen STUEBING, Buedingen (DE)

(73) Assignee: GM GLOBAL TECHNOLOGY OPERATIONS LLC, Detroit, MI (US)

(21) Appl. No.: 13/356,001

(22) Filed: Jan. 23, 2012

(30) Foreign Application Priority Data
Jan. 22, 2011 (DE) 10 2011 009 209.9

(51) Int. Cl. G06F 7/00

(52) U.S. Cl. 701/2; 701/1

(57) ABSTRACT

A method is provided for the lane monitoring of a motor vehicle travelling on a road. Position data of the motor vehicle are provided that are determined in at least one infrastructure device arranged adjacent to the road with a storage device with card reader. The card data contains information regarding a course of at least one lane of the road. With a determined distance covered of the motor vehicle and with the card data it is determined if the motor vehicle is at least partially leaving a lane of the road travelled on by the motor vehicle. If it is determined that the motor vehicle is at least partially leaving the lane, a sending of a message from the at least one infrastructure device to the motor vehicle takes place.

### CROSS-REFERENCE TO RELATED APPLICATION

This application claims priority to German Patent Application No. 10 2011 009 209.9, filed Jan. 22, 2011, which is incorporated herein by reference in its entirety.

### TECHNICAL FIELD

The technical field relates to a method and a system for the lane monitoring of a motor vehicle, a motor vehicle, an infrastructure device, a computer program product, and a computer-readable medium.

### BACKGROUND

From U.S. Pat. No. 7,317,973 B2, a method for the automatic vehicle driving is known, where infrastructure data is wirelessly transmitted to the vehicle and commands for the vehicle driving are calculated with the infrastructure data. The infrastructure data are loaded for at least one portion of the route located immediately ahead in a separate memory of the vehicle, the current position of the vehicle is continuously determined with a precise positioning system and the commands are calculated with the position data and the stored infrastructure data.

At least one object is to state a method and a system for the lane monitoring of a motor vehicle, a motor vehicle, an infrastructure device, a computer program product and a computer-readable medium which make possible a reduction of a data quantity for the lane monitoring to be transmitted. In addition, other objects, desirable features, and characteristics will become apparent from the subsequent summary and detailed description, and the appended claims, taken in conjunction with the accompanying drawings and this background.

### SUMMARY

A method is provided for the lane monitoring of a motor vehicle driving on a road that comprises determining of position data of the motor vehicle takes place, providing of the determined position data of the motor vehicle in at least one infrastructure device arranged adjacent to the road takes place. Here, the at least one infrastructure device comprises a storage device with card data. The card data contain information regarding a course of at least one lane of the road at least in a region of the surroundings of the at least one infrastructure device. Furthermore, determining of a driving course of the motor vehicle with the determined position data takes place. Furthermore, determining with the determined driving course of the motor vehicle and with the card data if the motor vehicle is at least partially leaving a lane of the road on which the motor vehicle is travelling. If it is determined that the motor vehicle is at least partially leaving the lane, sending of a message from the at least infrastructure device to the motor vehicle takes place. The message in this case contains information that the motor vehicle is at least partially leaving the lane.

A method according to this embodiment has the advantage that a data quantity to be transmitted is significantly smaller than with a method where infrastructure data are wirelessly transmitted to the vehicle. This is due to the message regarding the leaving of the lane having a substantially smaller size than infrastructure data to be sent. The method according to the mentioned embodiment thus makes possible in advantageous manner a reduction of the data quantity for the lane monitoring to be transmitted and thus additionally a reduction of the required transmission bandwidths for the provision of the data. Furthermore, the method makes possible a reduction of the storage requirement and of the computation capacities of the motor vehicle.

The method according to the mentioned embodiment additionally makes possible an improved lane monitoring of the motor vehicle driving on the road. In particular, during nighttime driving and in poor vision conditions, determining if the motor vehicle is at least partially leaving the lane on which said vehicle is travelling can be determined more reliably with the card data than with camera-based lane monitoring systems. An image evaluation of road markings in darkness or poor vision conditions is significantly less accurate than during daytime driving.

In a further embodiment, following a reception of the message sent by the at least one infrastructure device an automatic actuation of at least one element of the motor vehicle, selected from the group consisting of a warning device, a steering device and a braking device, takes place in addition. Because of this, the occupants of the motor vehicle, in particular the driver of the motor vehicle, can be informed about the leaving of the lane or the driving course of the motor vehicle corrected through an automatic steering and if applicable braking intervention and said vehicle be again completely returned into the lane.

In a further embodiment, the motor vehicle comprises a driver assistance system. The drive assistance system is designed as lane-holding assistant. The provision of the determined position data of the motor vehicle in this case is preferably effected in the event that the driver assistance system is activated. Thus, the sending of the message to the motor vehicle and if applicable of the automatic actuation of the mentioned elements only takes place with activated lane keeping assistant and thus merely in situations, in which the lane monitoring is desired by the driver of the motor vehicle. Because of this, outputting of a warning message or an automatic intervention in the driving dynamics upon an intended lane change of the motor vehicle is avoided.

In addition, if it is determined that the motor vehicle is at least partially leaving the lane, a direction, in which the motor vehicle is leaving the lane, can be determined. The message sent by the at least one infrastructure device in this configuration contains information regarding the determined direction. Thus, the message includes the information as to whether a lane has been breached on the left side or on the right side, because of which the occupants of the motor vehicle in a further improved manner can be notified or an automatic intervention in the driving dynamics can be reliably affected.

In a further embodiment, signature data are additionally sent from the motor vehicle in the at least one infrastructure device. In addition or alternatively, the message sent to the motor vehicle by the at least one infrastructure device can be provided with signature data. Because of this, the security for the data transmission can be advantageously increased in each case.

Furthermore, determining of the lane of the road travelled on by the motor vehicle can take place with data determined by at least one optical camera of the motor vehicle. The automatic actuation of the at least one element in this embodiment takes place in the event that it is determined with the data determined by the at least one infrastructure device, i.e., with the determined driving course of the motor vehicle and with the card data and with the data determined by the at least one optical camera of the motor vehicle that the motor vehicle is at least partially leaving the lane. Thus, a sensor fusion is carried out, as a result of which the accuracy of the method can be further increased.

In a further embodiment of the method, a degree of the tiredness of a driver of the motor vehicle is additionally determined based on the determined driving course. Thus, the determined driving course is provided as input parameter for a driver state detection, which is also called driver drowsiness detection. Furthermore, data determined with a steering angle sensor, an optical camera and/or an accelerator pedal sensor could be provided as input parameter for the driver state detection. Because of this, the state of the driver of the motor vehicle can be determined to as accurate a degree as possible.

If the determined degree of the tiredness of the driver exceeds a predetermined threshold value, automatic actuation of at least one element of the motor vehicle, selected from the group consisting of a braking device, a driving device, a steering device and a warning device preferably takes place. Because of this, the driver of the motor vehicle can be warned or an automatic intervention in the driving dynamics take place, because of which the driving safety can be increased in an advantageous manner.

The determined driving course in a further embodiment is sent from the at least one infrastructure device to at least one infrastructure device arranged adjacently. Thus a transfer protocol between adjacent infrastructure devices is carried out, because of which the lane monitoring can be maintained over extended distances.

Determining the position data of the motor vehicle preferably takes place with a position determination device of a navigation system of the motor vehicle. Because of this, the number of components additionally required for the lane monitoring can be reduced in an advantageous manner. Providing the determined position data of the motor vehicle in this configuration includes sending of the determined position data to the at least one infrastructure.

In a further embodiment, determining of the position data of the motor vehicle additionally or alternatively takes place with data of at least one sensor outside the vehicle, for example with data determined by a radar sensor or a lidar sensor of the at least one infrastructure device. Because of this, a sensor fusion can be carried out or position data of motor vehicles, which do not have their own positioning device, can also be determined.

Furthermore, data regarding a speed and/or dimensions of the motor vehicle can be sent to the at least one infrastructure device. Determining as to whether a motor vehicle is at least partially leaving a lane of the road travelled by the motor vehicle in this embodiment is additionally carried out with the sent data regarding the speed or the dimensions of the motor vehicle. Because of this, the leaving of the lane can be determined to a further improved degree. For example, the exact position of the positioning device within the motor vehicle can be transmitted to the at least one infrastructure device. This makes possible an earlier detection of the leaving of the lane.

A motor vehicle is also provided having a positioning device, which is designed for determining position data of the motor vehicle. In addition, the motor vehicle comprises a first sending device, which is designed for the sending of the determined position of the motor vehicle to at least one infrastructure device arranged adjacent to a road travelled on by the motor vehicle. Furthermore, the motor vehicle comprises a first receiving device, which is designed for receiving a message from the at least one infrastructure device. The message contains information that the motor vehicle is at least partially leaving a lane of the road travelled on by the motor vehicle. In addition to this, the motor vehicle comprises an actuating device designed for actuating at least one element of the motor vehicle selected from the group consisting of a warning device, a steering device and a braking device following a reception of the message sent by the at least one infrastructure device.

Furthermore, an infrastructure device is provided having a second receiving device. The second receiving device is designed for receiving determined position data of at least one motor vehicle. In addition to this, the infrastructure device comprises a storage device with card data containing information regarding a course of at least one lane of a road arranged adjacent to the infrastructure device at least in a region of the surroundings of the infrastructure device. Furthermore, the infrastructure device comprises a first determining device, which is designed for determining a driving course of the motor vehicle with the transmitted position data. Furthermore, the infrastructure device comprises a second determining device designed for determining with the determined driving course of the motor vehicle and with the card data if the motor vehicle is at least partially leaving a lane of the road travelled on by the motor vehicle. In addition to this, the infrastructure device comprises a second sending device that is designed for sending a message from the infrastructure device to the motor vehicle if it is determined that the motor vehicle is at least partially leaving the lane. Here, the message contains information that the motor vehicle is at least partially leaving the lane.

In addition, a system is provided for the lane monitoring of a motor vehicle driving on a road. The system comprises at least one motor vehicle and at least one infrastructure device according to the mentioned embodiments. Here, the motor vehicle for example is a passenger car or a commercial vehicle. The motor vehicle, the infrastructure device and the system for the lane monitoring according to embodiments have the advantages already mentioned in connection with the method, which at this point are not repeated again to avoid repetitions.

The system for the lane monitoring can additionally comprise a first determining device that is designed for determining a degree of the tiredness of a driver of the motor vehicle based on the determined driving course. The third determining device in this case is preferably part of the motor vehicle.

Furthermore, a computer program product is provided which, when it is executed on a computer unit of a motor vehicle travelling on a road, prompts the computer unit to carry out the following steps. The computer unit is prompted for determining position data of the motor vehicle. In addition, the computer unit is prompted for sending the determined position data of the motor vehicle to at least one infrastructure device arranged adjacent to the road. In addition, the computer unit is prompted to receive a message from the at least one infrastructure device. The message contains information that the vehicle is at least partially leaving a lane of the road travelled on by the motor vehicle. In addition, the computer unit following a reception of the message sent by the at least one infrastructure device is prompted for the automatic actuation of at least one element of the motor vehicle, selected from the group consisting of a warning device, a steering device and a braking device.

In addition, a computer-readable medium is provided on which a computer program product according to the mentioned embodiment is stored. The computer program product and the computer-readable medium comprise advantages already mentioned in connection with the method according to the application, which at this point are not mentioned again to avoid repetitions.

### BRIEF DESCRIPTION OF THE DRAWINGS

The present invention will hereinafter be described in conjunction with the following drawing figures, wherein like numerals denote like elements, and:

FIG. 1 shows a flow diagram of a method for the lane monitoring of a motor vehicle according to a first embodiment;

FIG. 2 shows a flow diagram of a method for the lane monitoring of a motor vehicle according to a second embodiment;

FIG. 3A to FIG. 3D show an example of a traffic situation in which the method according to the application can be employed; and

FIG. 4 shows a system for the lane monitoring according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

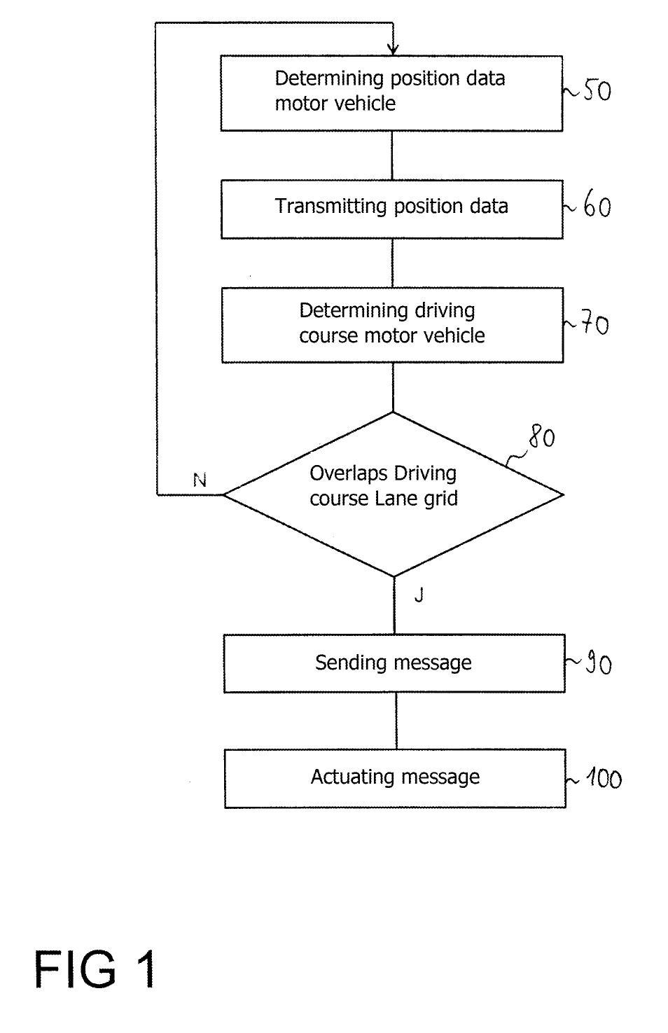

FIG. 1 shows a flow diagram of a method for the lane monitoring of a motor vehicle travelling on a road according to a first embodiment. The motor vehicle for example is a passenger car or a commercial vehicle. In the embodiment shown, determining of position data of the motor vehicle takes place in a step 50. Determining of the position data of the motor vehicle is carried out for example with a positioning device of a navigation system of the motor vehicle, i.e., with a satellite-based positioning system.

In a step 60, the determined position data of the motor vehicle are provided in at least one infrastructure device arranged adjacent to the road. In the shown embodiment, this is carried out by transmitting the position data to the at least one infrastructure device. Transmitting the position data is carried out, for example, in the event that a driver assistance system of the motor vehicle designed as lane keeping assistant is being activated or is activated. The at least one infrastructure device comprises a storage device with card data. The card data contain information regarding a course of at least one lane of the road at least in a region of the surroundings of the at least one infrastructure device.

In a step 70, a driving course of the motor vehicle is determined with the transmitted position data. Furthermore, it is determined in a step 80 if the motor vehicle is at least partially leaving a lane of the road travelled on by the motor vehicle. The determining is carried out with the determined driving course of the motor vehicle and with the card data. Here, in the embodiment shown, it is checked if there is an overlap of the driving course with a lane grid, which is part of the information regarding the course of the lanes stored in the storage device.

If the determined driving course does not overlap the lane grid the steps 50, 60, 70 and 80 are carried out repeatedly.

If, by contrast, it is determined that there is an overlap of the driving force with the lane grid, i.e. if it is determined that the motor vehicle is at least partially leaving the lane, a sending of a message from the at least one infrastructure device to the vehicle takes place in a step 90. The message in this case contains information that the motor vehicle is at least partially leaving the lane. Here, if in the step 80 an overlapping of the driving course with the lane grid is established, a direction, in which the motor vehicle is leaving the lane, can be additionally determined and the sent message contain information regarding the determined direction.

Following a reception of the message sent by the at least one infrastructure device an automatic actuation of at least one element of the motor vehicle, selected from the group consisting of a warning device, a steering device and a braking device takes place. Here, if the motor vehicle comprises at least one optical camera, the lane of the road travelled on by the motor vehicle can be determined in addition with the data determined by the at least one optical camera. The automatic actuation of the at least one element in this configuration, if determination with the data determined by the at least one infrastructure device and with the data determined by the at least one optical camera is made that the motor vehicle is at least partially leaving the lane.

In addition to the position data, signature data can be additionally sent to the at least one infrastructure device in the step 60. In addition or alternatively, the message sent from the at least one infrastructure device in the step 90 to the motor vehicle can be provided with signature data. This makes possible a further increase of the security in the wireless communication between the motor vehicle and the infrastructure device. Furthermore, the determined driving course can be sent from the at least one infrastructure device to at least one infrastructure device arranged adjacently. Because of this, the lane monitoring can be maintained over longer distances.

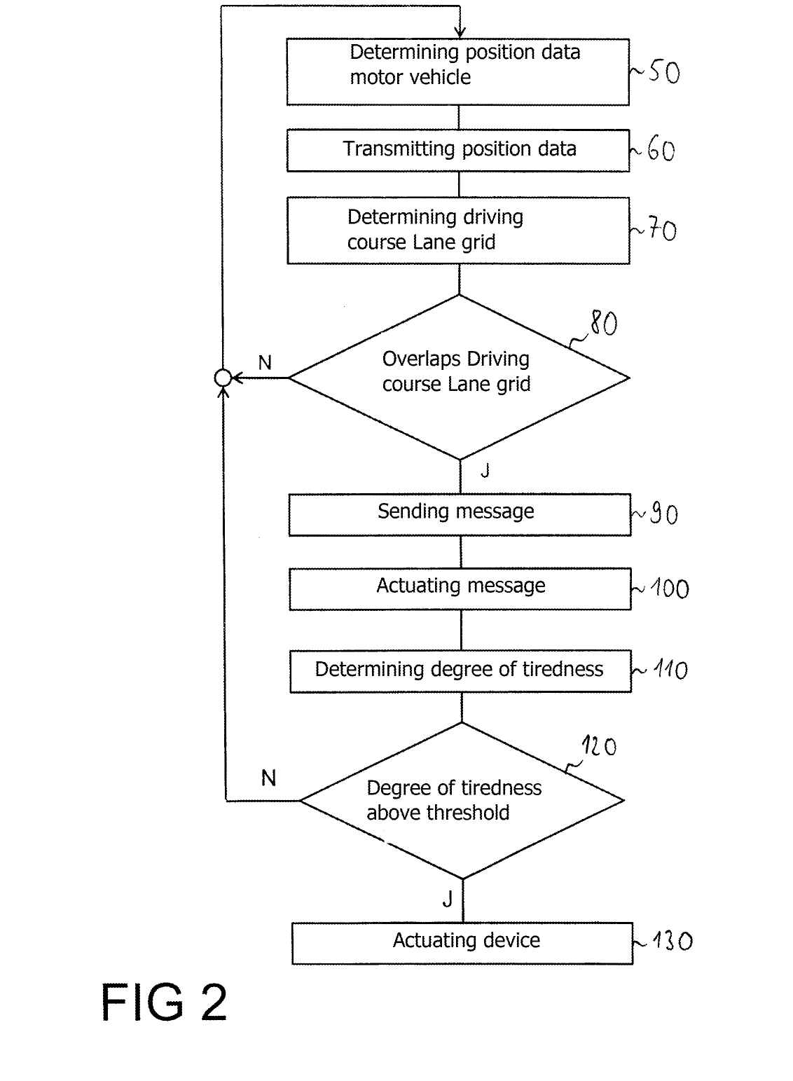

FIG. 2 shows a flow diagram of a method for the lane monitoring of a motor vehicle travelling on a road according to a second embodiment of the application. The motor vehicle again is for example a passenger car or a commercial vehicle. In a step 50, a determining of position data of the motor vehicle and in a step 60 a transmitting of the determined position data of the motor vehicle to at least one infrastructure device arranged adjacently to the road takes place according to the steps 50 and 60 of the first embodiment shown in FIG. 1. Furthermore, in a step 70, a driving course of the motor vehicle with the transmitted position data is determined and in a step 80 it is determined if the motor vehicle is at least partially leaving a lane of the road travelled on by the motor vehicle. This is likewise carried out in accordance with the steps 70 and 80 of the first embodiment shown in FIG. 1.

If in the step 80 it is determined that the determined driving course does not overlap the lane grid the steps 50 60, 70 and 80 are carried out repeatedly. If however it is determined that the driving course does overlap the lane grid a message from the at least one infrastructure device is sent to the motor vehicle in a step 90, where the message contains information that the motor vehicle is at least partially leaving the lane. In addition, following a reception of the message sent by the at least one infrastructure device an automatic actuation of at least one element of the motor vehicle selected from the group consisting of a warning device, a steering device and a braking device takes place in a step 100. The steps 90 and 100 in this case are carried out corresponding to the steps 90 and 100 of the first embodiment shown in FIG. 1.

Here, if the motor vehicle comprises at least one optical camera, the lane of the road travelled on by the motor vehicle can be additionally determined with data determined by the at least on optical camera. The automatic actuation of the at least one element in this configuration, if determination with the data determined by the at least one infrastructure device and with the data determined by the at least one optical camera is made that the motor vehicle is at least partially leaving the lane.

In a step 110, a degree of the tiredness of a driver of the motor vehicle based on the determined driving course is determined in addition. For example, it is determined if the driving force comprises a drifting movement. In addition to the determined driving course, further input parameters for determining the degree of tiredness can be used, for example data of a steering angle sensor, of an optical camera and/or of an accelerator pedal sensor of the motor vehicle.

In a step 120, it is checked if the determined degree of the tiredness exceeds a predetermined threshold value. If the determined degree of the tiredness does not exceed the predetermined threshold value, the steps 50, 60, 70 and 80 and if applicable steps 90 to 120 are carried out repeatedly. If however the determined degree of the tiredness of the driver exceeds the predetermined threshold value, at least one element of the motor vehicle selected from the group consisting of a braking device, a driving device, a steering device and a warning device is automatically actuated in a step 130.

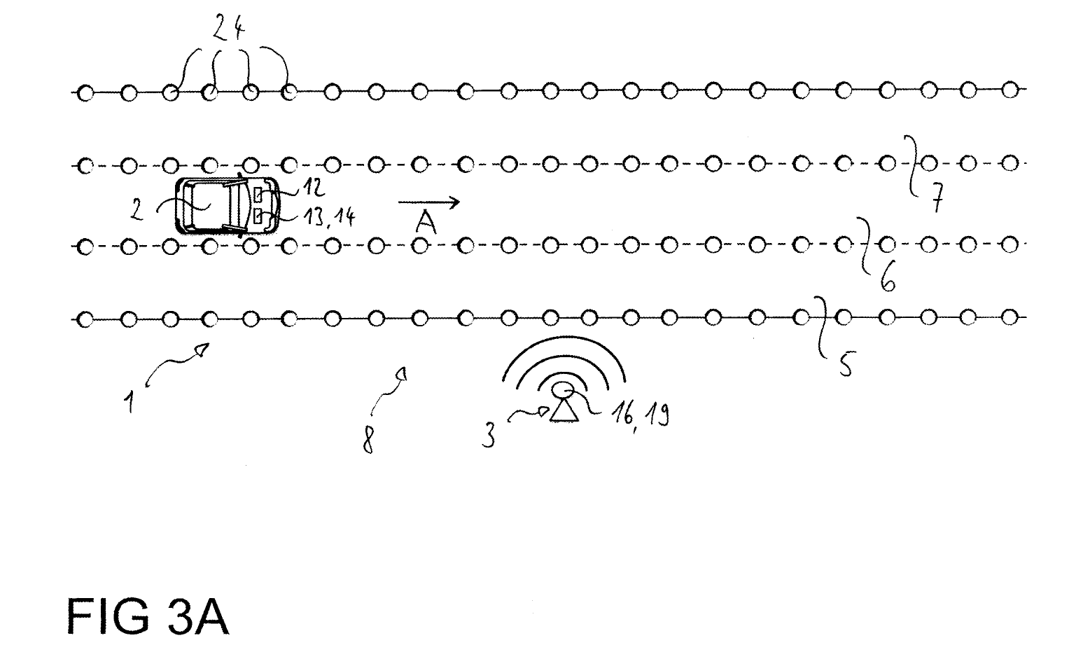

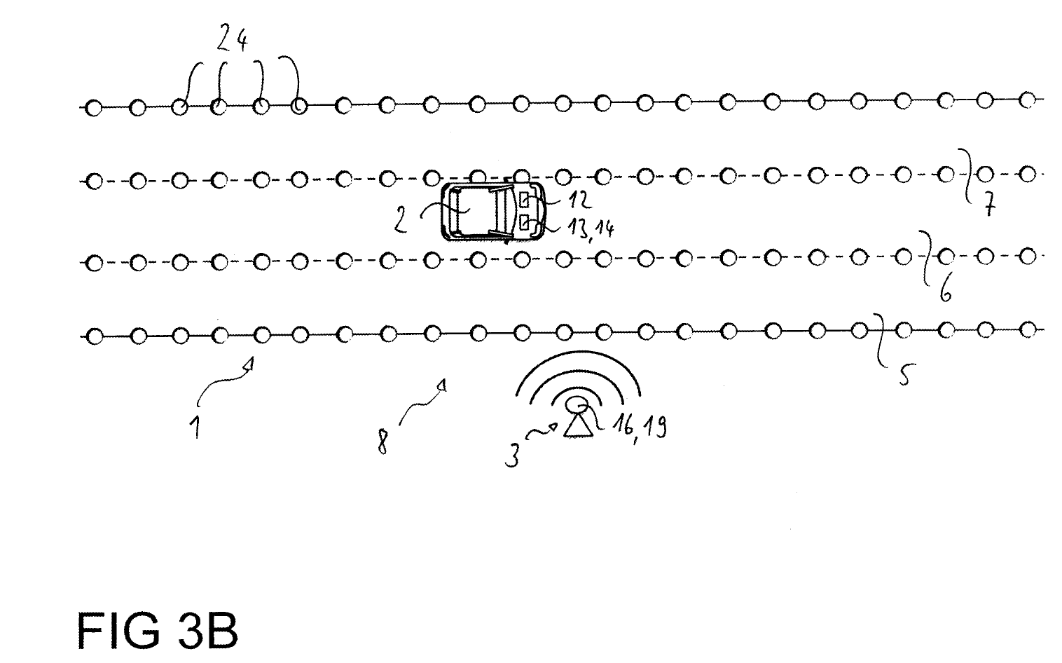

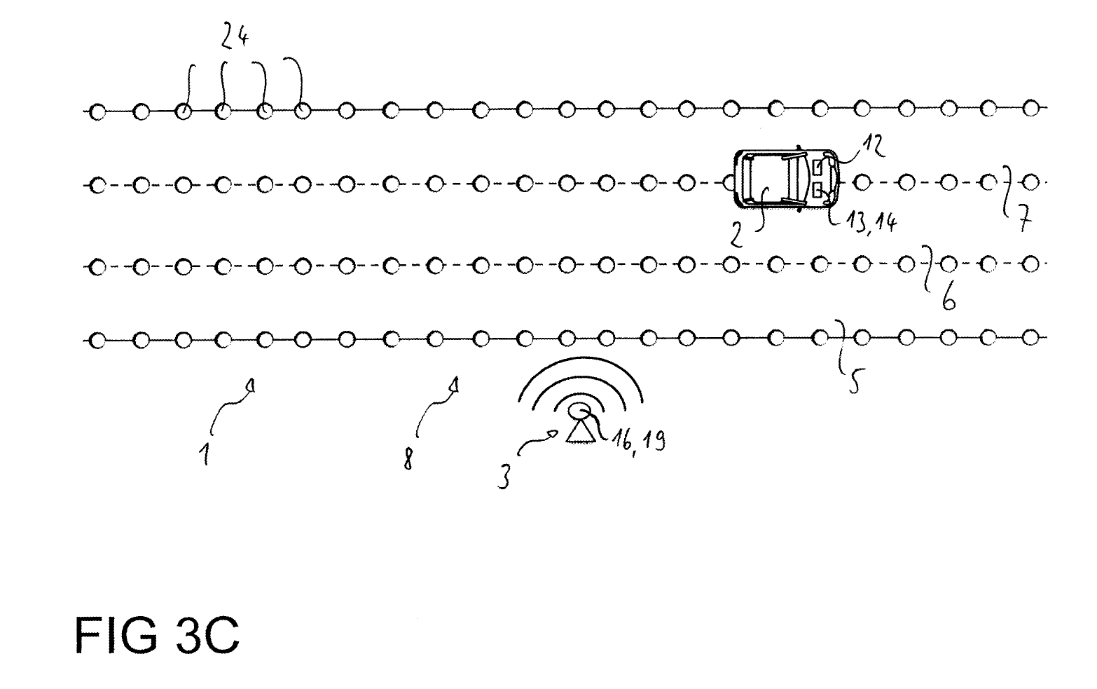

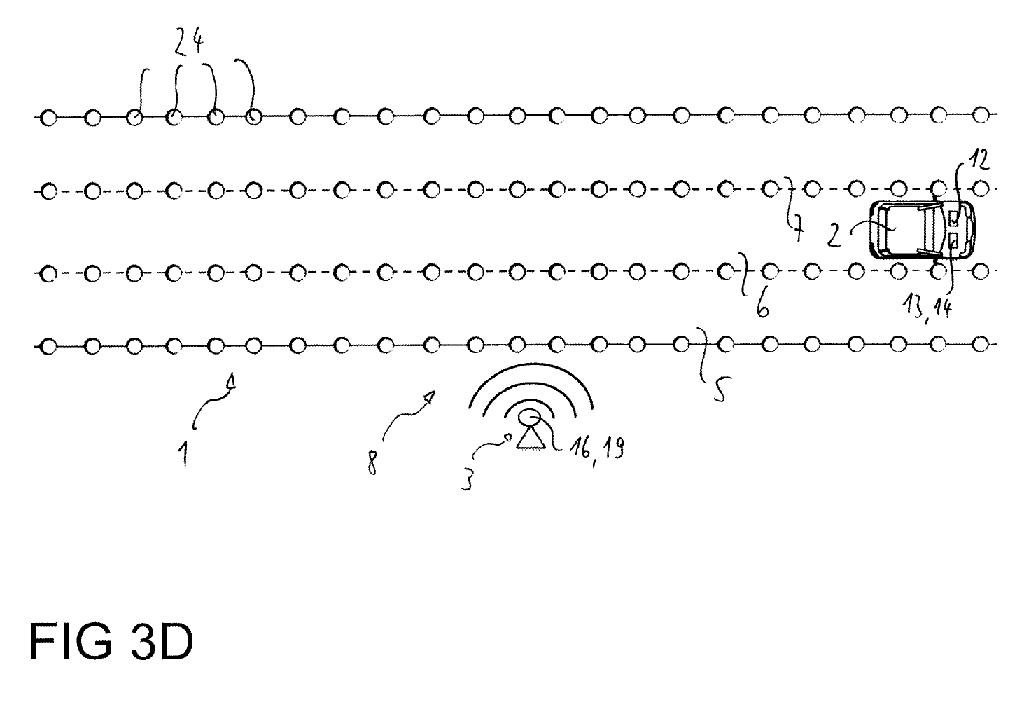

FIG. 3A to FIG. 3D show an example of a traffic situation in which the method according to the embodiments, particularly the methods according to the embodiments shown in the FIG. 1 and FIG. 2 can be employed. Components with the same functions are marked with the same reference characters here and are not explained repeatedly in the following.

To this end, FIG. 3A shows a first point of time at which a motor vehicle 2, which in the shown embodiment is a passenger car, travels on a first lane 6 of a road 1 in a driving direction represented schematically with an arrow A. In addition to the first lane 6, the road 1 comprises further lanes 5 and 7 in driving direction of the motor vehicle 2, wherein the lanes 5 and 7 are arranged on opposite sides of the first lane 6. The road 1 is for example part of a motorway or a highway.

The motor vehicle 2 is equipped with a so-called C2X communications module. Corresponding communication systems are also called vehicle-to-vehicle or vehicle-to-infrastructure communications systems or car-to-car (C2C) or car-to-infrastructure (C2I) communications systems. To this end, the motor vehicle 2 comprises a first sending device 13 and a first receiving device 14. In the configuration shown, the first sending device 13 has a sending frequency of approximately 5.9 GHz and the first receiving device 14 has a receiving frequency of likewise approximately 5.9 GHz. In the embodiment shown, the first sending device 13 and the first receiving device 14 form a common antennae element.

In addition, the motor vehicle 2 comprises a positioning device 12, which for example is part of a navigation system of the motor vehicle 2 that is not shown in more detail. Furthermore, the motor vehicle 2 comprises sensors, which are not shown in more detail for determining the speed and the driving direction of the motor vehicle 2.

With the C2X communications module, the motor vehicle 2 periodically sends mobility data, for example position, speed and direction of the motor vehicle 2 at an interval of for example one second, wherein the interval upon a severe change of the motor vehicle 2 can be reduced as far as to approximately 100 ms. These periodically send messages, which also contain the mobility data of the motor vehicle 2, are also called CAMs (co-operative awareness messages).

The accuracy of a positioning of the motor vehicle 2 with the positioning device 12 with a satellite-based system, for example a GPS system, typically amounts to approximately 1 to 2 meters. An increase of the accuracy can be achieved by using a DGPS system (differential GPS).

The shown road section, for which, as is explained in the following, a lane keeping functionality is carried out, is covered with infrastructure devices arranged adjacently to the road 1, of which an infrastructure device 3 is shown in FIG. 3A. Such roadside infrastructure devices are also called RSUs (roadside units) and can be arranged next to the road and above the road. The RSUs are placed for example at a spacing of 500 to 1,000 m at the road side and comprise detailed information regarding the local course of the road in their sending range, which amounts to, for example, approximately 800 to approximately 1,000 m. Among other things, this includes the exact positioning, the course and the demarcation of the individual lanes, i.e., in the situation shown of the lanes 5, 6 and 7. To this end, the infrastructure device 3 comprises a so-called C2X lane keeping control unit which is not shown in more detail in FIG. 3A, which comprises a grid of the individual lanes 5, 6 and 7, for example in the form of GPS reference points with a minimum spacing of approximately 1 meter. In FIG. 3A, the reference points are schematically shown as a lane grid 24. If required, for example in the event of road works, the grid can be dynamically adjusted.

The infrastructure device 3 thus comprises card data with information regarding a course of the lanes 5, 6 and 7 of the road 1 in a region of the surroundings 8 of the infrastructure device 3. In addition, the infrastructure device 3 comprises a second receiving device 16 and a second sending device 19, which have a transmission frequency of approximately 5.9 GHz, corresponding to the first receiving device 14 and the first sending device 13 of the motor vehicle 2.

In the following, a protocol regarding communication between the motor vehicle 2 and the infrastructure device 3 according to an embodiment is shown. The driver of the motor vehicle 2, who is not shown in more detail in FIG. 3A, activates the lane monitoring function, which is also called lane-keeping functionality, by actuating a vehicle HMI (human machine interface, man-machine interface) which is not shown in more detail.

A so-called C2X lane keeping control unit on the motor vehicle 2 searches for receiving signals from surrounding RSUs offering this service. If a corresponding RSU is present in the vicinity, as is shown in FIG. 3A with the infrastructure device 3, a service request is sent out by the control unit. The C2X lane keeping control unit on the infrastructure device 3 receives the request, sends a confirmation back, and starts distance covered monitoring device for the motor vehicle 2, which is also called vehicle tracker. The vehicle tracker receives the periodically sent CAM messages of the motor vehicle 2 and compares the position of the motor vehicle 2 contained therein with the stored grid of the road course. To this end, a second point of time and a third point of time of the traffic situation is shown in FIG. 3B and FIG. 3C respectively. The second point of time in this case is after the first point of time shown in FIG. 3A and the third point of time after the second point of time. In the shown situation, the motor vehicle 2 has continued to move on the lane 6.

If the infrastructure device 3 detects an overlapping of the driving force with the lane grid, i.e., if the motor vehicle 2 is at least partially leaving the lane 6, as is shown in FIG. 3C, a C2X message is generated and sent to the motor vehicle 2. In addition to an identification, which is also called ID, the message includes the information as to which lane (left side or right side) has been breached.

The motor vehicle 2 receives the sent C2X message. If the motor vehicle 2 additionally has a camera system for the lane locating, a sensor fusion is carried out if required in order to increase the liability of the instruction. Following this, a warning of the driver via the vehicle HMI takes place. In addition or alternatively to this, a vehicle steering intervention can also be carried out directly, if a safety-critical situation is present. In order to guarantee the data integrity of the sent messages and the sender authenticity, a digital signature with corresponding sender certificate is appended to each message.

FIG. 3D shows the motor vehicle 2 at a fourth point of time following the outputting of the warning message or the automatic intervention in the driving dynamics. Through the mentioned measures, the motor vehicle 2 in FIG. 3D is again entirely on the lane 6. In order to maintain the C2X lane monitoring function over extended distances, a so-called handover protocol between adjacent RSUs is carried out. In the case of RSUs, which are not interconnected, the protocol is again carried out according to the mentioned activating step by actuating the vehicle HMIs.

The method for lane monitoring according to the shown embodiment advantageously leads to a cost reduction, since elaborate and expensive methods for lane monitoring, which are based on a graphic evaluation, can be replaced by the C2X lane keeping control unit or complemented with a center fusion. Thus, a lane keeping assistant can be realized very simply and effectively. The lane keeping functionality is thus made possible also for lower priced vehicles.

In addition, the method offers higher reliability, can be easily implemented in the form of a control unit, and does not require any elaborate algorithms for the calculation. In the embodiment shown, the mode of operation of the control unit is based on the C2X technology, which is particularly reliable. In addition, the function is made possible through the control unit and is thus independent of a penetration rate of all vehicles equipped with C2X. The functionality is thus utilizable even in a very early phase.

Furthermore, no card material is required with this control unit since the detection is carried out by the infrastructure. The lane keeping functionality is thus made possible also for vehicles without their own card data or without own navigation system. Moreover, compared with a camera-based detection, a very good detection rate is made possible also during nighttime driving or driving with poor visibility.

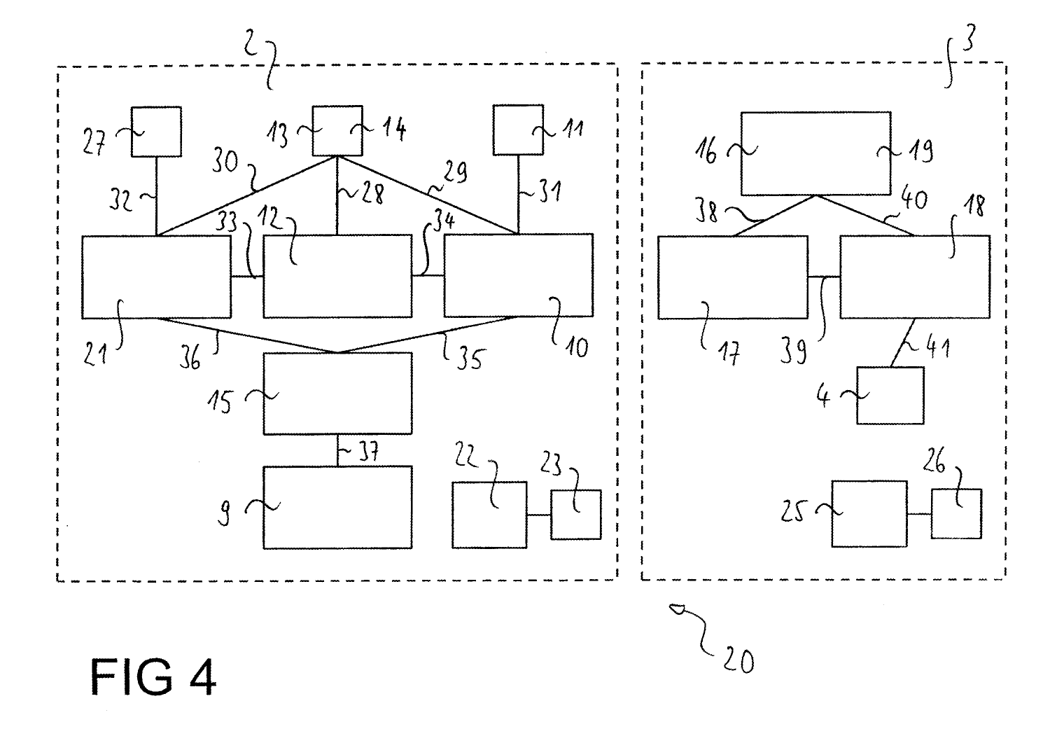

FIG. 4 shows a system 20 for the lane monitoring according to an embodiment. The system 20 includes the motor vehicle shown in the FIG. 3A to FIG. 3D and the infrastructure device 3 likewise shown there. Components with the same functions as in the preceding figures are marked with the same reference characters and are not explained again in the following.

In the embodiment shown, the motor vehicle 2 as already explained comprises a positioning device 12, which is designed for determining position data of the motor vehicle 2. In addition, the motor vehicle 2 comprises a driver assistance system 10, which is designed as lane keeping assistant. In addition, the motor vehicle 2 comprises a first sending device 13, which is designed for sending the determined position data of the motor vehicle 2 to the infrastructure device 3. The positioning device 12 for this purpose is connected to the first sending device 13 via a signal line 28. Furthermore, the positioning device 12 is connected via a signal line 34 to the driver assistance system 10 and the latter to the first sending device 13 via a signal line 29.

The infrastructure device 3 comprises a second receiving device 16, which is designed for receiving the determined position data. In addition, the infrastructure device 3 comprises a storage device 4 with card data. The card data contains information regarding a course of the lanes of the road arranged adjacent to their infrastructure device 3. Furthermore, the infrastructure device 3 comprises a first determining device 17, which is designed for determining a distance covered of the motor vehicle 2 with the transmitted position data. The first determining device 17 for this purpose is connected to the second receiving device 16 via a signal line 38. Moreover, the infrastructure device 3 comprises a second determining device 18, which is designed for determining whether the motor vehicle 2 is at least partially leaving the lane of the road travelled on by the motor vehicle 2. Determining is carried out with the determined distance covered of the motor vehicle 2 and with the card data. To this end, the second determining device 18 is connected via a signal line 38 to the first determining device 17 and via a signal line 41 to the storage device 4.

In addition, the infrastructure device 3 comprises a second sending device 19, which is designed for sending a message from the infrastructure device 3 to the motor vehicle 2 in the event that it is determined that the motor vehicle 2 is at least partially leaving the lane. Here, the message contains information that the motor vehicle 2 is at least partially leaving the lane. To this end, the second sending device 19 is connected via a signal line 40 to the second determining device 18.

The motor vehicle 2 comprises a first receiving device 14, which is designed for receiving the message sent by the infrastructure device 3. The received message is transmitted via the signal line 29 to the driver assistance system 10 of the motor vehicle 2. The latter is additionally connected via a signal line 31 to an optical camera 31 of the motor vehicle 2. Thus, in the shown embodiment, a fusion of the determined data is made possible.

In addition to the driver assistance system 10, the motor vehicle 2 in the embodiment shown comprises a further driver assistance system for a driver state detection. To this end, the motor vehicle 2 comprises a third determining device 21, which is designed for determining a degree of the tiredness of a driver of the motor vehicle 2. Determining the degree of the tiredness is in the embodiment shown is carried out based on the determined distance covered and with additional data, which are determined with at least one sensor 27, for example data of a steering angle sensor, an optical camera and/or an accelerator pedal sensor. To this end, the at least one sensor 27 is connected via a signal line 32 to the third determining device 21. In addition, the third determining device 21 is connected via a signal line 30 to the first receiving device 14 and via a signal line 33 to the positioning device 12.

Via a signal line 35, the driver assistance system 10, which forms the lane keeping assistant, is connected to a control unit in the form of an actuating device 15, which is designed for the automatic actuation of at least one element 9 of the motor vehicle 2, selected from the group consisting of a warning device, a steering device, a braking device and a driving device. Furthermore, the actuating device 15 is connected via a signal line 36 to the third determining device 21, which makes possible the driver state detection, and via a control and signal line 37, to the at least one element 9.

In addition, the motor vehicle 2 comprises a computer unit 22 and a computer-readable medium 23. The computer-readable medium 23 a computer program product is stored which, when it is executed on the computer unit 22, prompts the computer unit 22 to carry out the abovementioned steps with the elements mentioned therein. To this end, the computer unit 22 is connected directly or indirectly to the corresponding elements in a manner, which is not shown in more detail. The computer program product for the lane monitoring or the computer program product for the driver state detection, which are also called applications or “apps”, can for example be provided by or obtained from a network.

In addition, the infrastructure device 3 comprises a computer unit 25 and a computer-readable medium 26. The computer-readable medium 26 a computer program product is stored which, when it is executed on the computer unit 25, prompts the computer unit 25 to carry out the steps of the described method for the lane monitoring with the elements mentioned therein. To this end, the computer unit 25 is directly or indirectly connected to the corresponding elements in a manner, which is not shown in more detail.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for a lane monitoring of a motor vehicle driving on a road, comprising:
determining position data of the motor vehicle;
providing the position data of the motor vehicle in at least one infrastructure device arranged adjacent to the road,
wherein the at least one infrastructure device comprises a storage device with card data, and
wherein the card data contains information regarding a course of at least one lane of the road at least in a region of surroundings of the at least one infrastructure device;
determining a distance covered of the motor vehicle with the position data;
determining if the motor vehicle is at least partially leaving the lane of the road travelled on by the motor vehicle with the distance covered of the motor vehicle and with the card data; and
sending of a message from the at least one infrastructure device to the motor vehicle if it is determined that the motor vehicle is at least partially leaving the lane,
wherein the message contains information that the motor vehicle is at least partially leaving the lane.

2. The method according to claim 1, further comprising actuating of an at least one element of the motor vehicle after a receipt of the message sent by the at least one infrastructure device.

3. The method according to claim 1,
wherein the motor vehicle comprises a driver assistance system,
wherein the driver assistance system is configured as a lane keeping assistant, and
wherein provision of the position data of the motor vehicle takes place in event that the driver assistance system is activated.

4. The method according to claim 1, further comprising determining a direction in which the motor vehicle is leaving the lane if it is determined that the motor vehicle is at least partially leaving the lane,
wherein the message sent by the at least one infrastructure device contains information regarding the direction.

5. The method according to claim 1, further comprising sending signature data to the at least one infrastructure device.

6. The method according to claim 2, further comprising determining the lane of the road travelled by the motor vehicle that takes place with data determined by at least one optical camera of the motor vehicle,
wherein the actuating of the at least one element of the motor vehicle takes place in event that with the data determined by the at least one infrastructure device and with the data determined by the at least one optical camera of the motor vehicle it is determined that the motor vehicle is at least partially leaving the lane.

7. The method according to claim 1, further comprising determining a degree of tiredness of a driver of the motor vehicle based at least in part on the distance covered

8. The method according to claim 7, further comprising automatically actuating at least one element of the motor vehicle if the degree of tiredness of the driver exceeds a predetermined threshold value.

9. The method according to claim 1, further comprising sending the distance covered from the at least one infrastructure device to at least one adjacently arranged infrastructure device.

10. A motor vehicle, comprising:
a positioning determining device configured to determine position data of the motor vehicle;
a first sending device configured to send the position data of the motor vehicle to at least one infrastructure device arranged adjacent to a road travelled on by the motor vehicle;
a first receiving device configured to receive a message from the at least one infrastructure device,
wherein the message contains information that the motor vehicle is at least partially leaving a lane of the road travelled on by the motor vehicle; and
an actuating device configured to actuate at least one element of the motor vehicle following a receipt of the message sent by the at least one infrastructure device.

11. An infrastructure device comprising:
a second receiving device configured to receive position data of a motor vehicle;
a storage device with card data,
wherein the card data contain information regarding a course of at least one lane of a road arranged adjacent to the infrastructure device at least in a region of surroundings of the infrastructure device;
a first determining device configured to determine a distance covered of the motor vehicle with the position data;
a second determining device configured to determine if the motor vehicle is at least partially leaving a lane of the road travelled on by the motor vehicle with the distance covered of the motor vehicle and with the card data; and
a second sending device configured to send a message from the infrastructure device to the motor vehicle in event that it is determined that the motor vehicle is at least partially leaving the lane,
wherein the message contains information that the motor vehicle is at least partially leaving the lane.

12. A computer readable medium embodying a computer program product, said computer program product comprising:
a monitoring program for a lane monitoring of a motor vehicle driving on a road, the monitoring program configured to:
determine position data of the motor vehicle;
provide the position data of the motor vehicle in at least one infrastructure device arranged adjacent to the road,
wherein the at least one infrastructure device comprises a storage device with card data, and
wherein the card data contains information regarding a course of at least one lane of the road at least in a region of surroundings of the at least one infrastructure device;
determine a distance covered of the motor vehicle with the position data;
determine if the motor vehicle is at least partially leaving the lane of the road travelled on by the motor vehicle with the distance covered of the motor vehicle and with the card data; and
send of a message from the at least one infrastructure device to the motor vehicle if it is determined that the motor vehicle is at least partially leaving the lane,
wherein the message contains information that the motor vehicle is at least partially leaving the lane.

13. The computer readable medium embodying the computer program product according to claim 12, wherein the monitoring program is further configured to actuate of at least one element of the motor vehicle after a receipt of the message sent by the at least one infrastructure device.

14. The computer readable medium embodying the computer program product according to claim 12,
wherein the motor vehicle comprises a driver assistance system,
wherein the driver assistance system is configured as a lane keeping assistant, and
wherein provision of the position data of the motor vehicle takes place in event that the driver assistance system is activated.

15. The computer readable medium embodying the computer program product according to claim 12, wherein the monitoring program is further configured to determine a direction in which the motor vehicle is leaving the lane if it is determined that the motor vehicle is at least partially leaving the lane,
wherein the message sent by the at least one infrastructure device contains information regarding the direction.

16. The computer readable medium embodying the computer program product according to claim 12, wherein the monitoring program is further configured to send signature data to the at least one infrastructure device.

17. The computer readable medium embodying the computer program product according to claim 13, wherein the monitoring program is further configured to determine the lane of the road travelled by the motor vehicle that takes place with data determined by at least one optical camera of the motor vehicle,
wherein the monitoring program is further configured to actuate the at least one element takes place in event that with the data determined by the at least one infrastructure device and with the data determined by the at least one optical camera of the motor vehicle it is determined that the motor vehicle is at least partially leaving the lane.

18. The computer readable medium embodying the computer program product according to claim 12, wherein the monitoring program is further configured to determine a degree of tiredness of a driver of the motor vehicle based at least in part on the distance covered.

19. The computer readable medium embodying the computer program product according to claim 18, wherein the monitoring program is further configured to actuate at least one element of the motor vehicle if the degree of tiredness of the driver exceeds a predetermined threshold value.

20. The computer readable medium embodying the computer program product according to claim 12, wherein the monitoring program is further configured to send the distance covered from the at least one infrastructure device to at least one adjacently arranged infrastructure device.
